(19) United States
(12) Patent Application Publication
(10) Pub. No.: US 2025/0376595 A1
(43) Pub. Date: Dec. 11, 2025

(54) BITUMEN-CONTAINING MIXTURES, METHOD FOR PRODUCTION AND USE THEREOF

(71) Applicant: LANXESS Deutschland GmbH, Cologne (DE)

(72) Inventors: Thomas Klein, Heidelberg (DE); Sandra Horstmann, Neuhofen (DE); Svenja Kusterer, Rheinsheim (DE)

(73) Assignee: LANXESS Deutschland GmbH, Cologne (DE)

(21) Appl. No.: 18/876,704

(22) PCT Filed: Jun. 16, 2023
(86) PCT No.: PCT/EP2023/066307

§ 371 Date: Dec. 19, 2024

(30) Foreign Application Priority Data
Jun. 24, 2022 (EP) 22180877.7

(51) Int. Cl. C08L 95/00; C08J 3/20; C08K 5/372

(52) U.S. Cl. CPC C08L 95/00; C08J 3/201; C08K 5/372; C08J 2395/00; C08J 2421/00; C08L 2555/22; C08L 2555/24; C08L 2555/52; C08L 2555/64

(57) ABSTRACT

The present invention relates to novel bitumen-containing mixtures, to a method for the production thereof and to the use thereof.

The present invention relates to novel bitumen-containing mixtures, to a method for the production thereof and to the use thereof.

### PRIOR ART

Bitumen is an important binder in asphalt that is used together with rock aggregates in road construction for strengthening road surfaces, in building construction for floor coverings, in hydraulic engineering and also in landfill construction for waterproofing.

In road construction with customary hot-mix application, the heated bitumen releases emissions (vapours, aerosols), the amount of which depends on the composition of the bitumen and on the temperature. The gases emitted are mostly alkanes, alkenes and lighter aromatics (benzene, toluene, ethylbenzene, xylene). In addition, depending on the bitumen or the crude oil from which it derives, they may also contain, for example, 0.1-5% of sulfur-containing hydrocarbons (Volatile Emissions from Hot Bitumen Storage Tanks, Francois Deygout, SHELL Bitumen, published online 1 Jun. 2010 in Wiley Online Library DOI 10.1002/ep.10444). The higher the temperature of the asphalt during road construction, the higher also the concentrations of the vapours and aerosols released. As a rule of thumb, lowering the temperature by 10 K results in a halving of emissions, thus lowering it by 30 K achieves an energy saving of 9 kWh per tonne of asphalt mix (asphalt guidelines “Lower-temperature asphalts” of the German Asphalt Association, April 2009, p. 7 of 52).

The Committee on Hazardous Substances in Germany has adopted a workplace limit value of 1.5 mg/m³ for vapours and aerosols during hot processing of bitumen.

On both health and environmental protection grounds, the aim must therefore be to keep the temperature of hot asphalt as low as technically possible during road construction. The key element here is the bitumen, via which the processing temperature of the asphalt can normally be controlled.

This can on the one hand be achieved in bitumen by mineral additives such as zeolites, which form foam bitumen by releasing water vapour, or through viscosity-reducing or “chemical” additives such as waxes or amines (Shell Bitumen Handbook, 6th ed., p. 406). However, these additives have drawbacks. The release of water vapour from the mineral additives consumes heat energy, amines as additives are hazardous substances with considerable aquatic toxicity, and waxes cause brittleness at low temperatures as a consequence of crystallisation (Value-Added Opportunities for Conventional and Atypical Asphalt Binders and Asphaltenes Derived from Alberta Oil Sands in Road Construction, Alberta Innovates File AI 2515, Public Final Report, submitted on: 15 Jan. 2021).

An alternative thereto could be glycerides, preferably triglycerides, for example in combination with fatty acids, as have been described in WO 2016/073442 as a bitumen substitute or as an adjuvant to improve the solubility of a polymer. A disadvantage here is however their low effectiveness.

EP-A 3262083 describes oils from renewable raw materials polymerized by sulfurization for road construction. This used oils or esters from renewable raw materials having a sulfur content of 0.001% to 8% by weight. A disadvantage here too is the low effectiveness of the triglycerides.

### Object of the Present Invention

Proceeding from the described prior art, the object of the present invention was to provide improved bitumen-containing mixtures with additives having correspondingly better performance, with which the processing temperature of the hot asphalt can be kept as low as possible during road construction.

It has surprisingly been found that this object can be achieved with a mixture comprising, in addition to bitumen, at least one sulfurized C₅-C₃₀ fatty acid and/or esters thereof with monofunctional C₁-C₈ alcohols having a sulfur content of 1% to 29% by weight and a proportion of di- and/or triglycerides of ≤5% by weight.

### Subject Matter of the Invention

The present invention provides mixtures comprising bitumen and at least one sulfurized C₅-C₃₀ fatty acid and/or at least one C₁-C₈alkyl ester of a sulfurized fatty acid and a monofunctional C₁-C₈ alcohol having a sulfur content of 1% to 29% by weight and a proportion of di- and/or triglycerides of ≤5% by weight.

The function of the bitumen, which makes up about 4-7% of the road surface, is that of a binder for the rock. This binder gives asphalt internal cohesion. It is therefore of great importance, since the bitumen adheres to the rock surface with high binding force.

Bitumen refers to a mixture of various organic substances that are either naturally occurring or are obtained by distillation from crude oil. Because of its biological origin, bitumen consists mainly of carbon and hydrogen. It is a low-volatility, dark-coloured complex mixture of organic substances having viscoelastic behaviour that changes with temperature.

Bitumen can for the purposes of the invention be any type of bitumen or bituminous material. For example, it can include bitumen that is naturally occurring, bitumen obtained in the processing of crude oil and/or other heavy hydrocarbons or else bitumen produced synthetically. Bitumen employable for the purposes of the invention is any commercial bitumen types, for example type 50/70 or 70/100 road bitumen. This preferably includes road bitumen according to DIN EN 12591.

The bitumen can for example have a viscosity at 60° C. of approx. 30-500 Pas, measured according to DIN EN 12596. The bitumen can in addition preferably have a penetration at 25° C. of about 20-220 (in units of 0.1 mm), measured according to DIN EN 1426, a standard test method for the penetration of bituminous materials (Siegen University Highway Research Institute, teaching material for road construction technology part 1, 2018).

The sulfurized C₅-C₃₀ fatty acid is for the purposes of the invention preferably aliphatic monocarboxylic acids from triglycerides obtained from natural oils such as palm oil, sunflower oil, maize oil, soya oil, linseed oil, rapeseed oil, tung oil, castor oil, tall oil, cottonseed oil, peanut oil, safflower oil, and/or maize stillage oil and sulfurized by reaction with elemental sulfur and optionally hydrogen sulfide. The reaction with elemental sulfur and optionally hydrogen sulfide takes place here preferably at temperatures of 120° C. to 180° C.

The C₁-C₈alkyl ester from a sulfurized fatty acid and monofunctional C₁-C₈ alcohol is preferably sulfurized products of the reaction of the abovementioned fatty acids from palm oil, sunflower oil, maize oil, soya oil, linseed oil, rapeseed oil, tung oil, castor oil, tall oil, cottonseed oil, peanut oil, safflower oil, and/or maize stillage oil with methanol and/or ethanol. The preparation of the C₁-C₈alkyl esters preferably takes place at temperatures of >40° C.

In a particularly preferred embodiment of the invention, the sulfurized C₅-Cao fatty acid and/or esters thereof with a monofunctional C₁-C₈ alcohol is compounds of the formula (I)

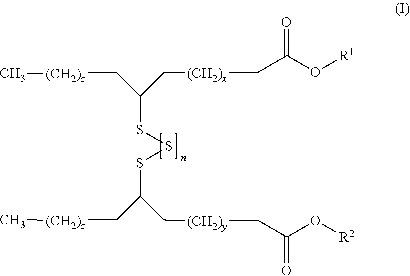

where
n=0-8,
R¹═H, C₁-C₈ alkyl, preferably C₁ or C₂ alkyl,
R²═H, C₁-C₈alkyl, preferably C₁ or C₂ alkyl,
x=0-10, preferably 4-6,
y=0-10, preferably 4-6 and
z=independently 0-20, preferably 7-9,
and/or (II)

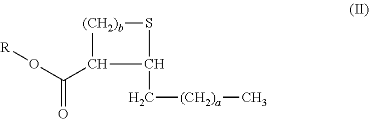

where
a=0-26, preferably 10-14,
b=0-3, preferably 0 and
R═H, C₁-C₈alkyl, preferably C₁ or C₂ alkyl.

The C₁-C₈alkyl ester from a sulfurized fatty acid and monofunctional C₁-C₈ alcohol is for the purposes of the invention particularly preferably a methyl or ethyl ester and most preferably a methyl ester.

Preference is given to using sulfurized C₁-C₈alkyl esters, preferably sulfurized methyl esters of fatty acids of vegetable or animal origin, for example oleic acid.

Where a sulfurized C₅-C₃₀ fatty acid and/or esters thereof with a monofunctional C₁-C₈ alcohol are used together, preference is given to a ratio of 50:50 to 10:90.

The sulfur content in the sulfurized C₅-C₃₀ fatty acid and/or in the esters thereof with a monofunctional C₁-C₈ alcohol is preferably 9-29% by weight, more preferably 10 to 27% by weight, most preferably 10-20% by weight, based on the sulfurized C₅-C₃₀ fatty acid and/or alkyl esters thereof.

It is further preferable that, in the sulfurized C₅-C₃₀ fatty acid and/or esters thereof with a monofunctional C₁-C₈ alcohol, the proportion of di- and/or triglycerides is <0.8% by weight, more preferably between 0.001% and 0.75% by weight, based on the fatty acid or alkyl esters thereof.

In a further preferred embodiment of the present invention, the sulfurized C₅-C₃₀ fatty acid and/or esters thereof with a monofunctional C₁-C₈ alcohol has a number-average molar mass Mn of <880 g·mol⁻¹, more preferably between 350 and 750 g·mol⁻¹, more preferably from 450 to 680 g·mol⁻¹. Reported values for the number-average molar mass Mn are based on measurement by gel-permeation chromatography (GPC) at 40° C. using a RI detector with tetrahydrofuran (THF) as eluent and with the “PSS-SDV” column combination from the supplier PSS as stationary phase (molecular weight range between 100 and 10 000 g/mol; column length 300 mm; column diameter 8 mm; particle size 5 μm; pore size 100, 500 and 10 000 Å), which was calibrated with polystyrene standards.

The amount of sulfurized fatty acid and/or of esters thereof with a monofunctional C₁-C₈ alcohol in the bitumen is preferably 0.01-25% by weight, preferably 1-10% by weight.

In a further embodiment of the present invention, the bitumen used comprises vulcanized rubber, preferably from shredded tyres, that, prior to being incorporated into the mixture of the invention, had preferably been treated with dialkyl polysulfides of the formula (III)

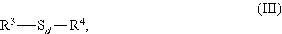

where R³ and R⁴ may be identical or different and represent a linear or branched C₁-C₁₈ alkyl radical and d represents numbers from 3 to 12, preferably 8. In a further embodiment of the invention, the dialkyl polysulfide of the formula (III) is preferably dioctyl pentasulfide and/or dioctyl tetrasulfide, more preferably dioctyl pentasulfide and/or dioctyl tetrasulfide, with branched C₈ alkyl.

The dialkyl polysulfide is used in an amount of preferably 1.5% to 3% by weight, more preferably 1.7% to 2.5% by weight, based on the vulcanized rubber.

The vulcanized rubber is sulfur-crosslinked rubbers based on polydienes of the R group, comprising natural rubbers (NR), butadiene rubbers (BR), styrene-butadiene rubbers (SBR), acrylonitrile-butadiene rubbers (NBR) and butyl rubbers (IIR), vulcanizates from rubbers having few double bonds or double-bond-free polymer main chains of the M group, comprising ethylene-propylene-diene rubber (EPDM), and mixtures of the mentioned rubbers of the R and M group. Particular preference is given to using rubber tyres as the source of the vulcanized rubber.

The vulcanized rubber, preferably the rubber tyres, is preferably used in a particle size of 0.15 to 3 mm, more preferably 0.2-1 mm. For such use it may be necessary to comminute the vulcanized rubber. This is ideally done using shredders and mills and/or cutters. Preference is given to using for this purpose double-shaft shredders and cutting mills.

In the treatment of the vulcanized rubber with the dialkyl polysulfides of the formula (III), the rubber is devulcanized through breakage of the sulfur bridges, thereby improving solubility in the bitumen. The treatment takes place preferably at temperatures of 130-150° C. The resulting mixture is then heat-treated preferably for less than 20 minutes and thereafter admixed with the bitumen.

The amount of dialkyl polysulfide of the formula (III) for the breakage of the sulfur bridges in the vulcanized rubber is preferably 1.5% to 3% by weight, more preferably 1.7% to 2.5% by weight, based on the amount of vulcanized rubber.

The breakage of the sulfur bridges in the vulcanized rubber with the dialkyl polysulfides of the formula (III) is effected preferably in accordance with the method described in EP-A-3771727. In a further preferred embodiment of the invention, the metered addition of the dialkyl polysulfide to the vulcanized rubber preferably takes place via a nozzle.

The present invention further provides in addition a method for producing the mixture of the invention, in which at least one sulfurized C₅-C₃₀ fatty acid and/or esters thereof with a monofunctional C₁-C₈ alcohol having a sulfur content of 1% to 29% by weight, preferably 8-29% by weight, more preferably 10-27% by weight and most preferably 10-20% by weight and a proportion of di- and/or triglycerides of ≤5% by weight and optionally dialkyl polysulfide of the formula (III) and vulcanized rubber or rubber devulcanized with dialkyl polysulfides is/are mixed with the bitumen at temperatures of 100 to 200° C.

In a preferred embodiment of the invention, the sulfurized C₅-C₃₀ fatty acid and/or esters thereof with a monofunctional C₁-C₈ alcohol is compounds of the formulas (I) and/or (II).

Mixing is effected preferably under mechanical stress. Mechanical stress means for the purposes of the invention the use of mixing units, such as preferably extruders, internal mixers, high-pressure homogenizers, such as in particular high-shear mixing devices, for example an Ultra-Turrax®, kneader and/or rolling mill. In industrial-scale operation, the use of extruders and/or internal mixers is particularly preferred, there being no particular restriction on the type of extruder and/or internal mixer. On a laboratory scale, particular preference is given to a high-shear mixing device, for example an Ultra-Turrax®, or else an anchor stirrer having at least two paddles.

### Further Subject Matter of the Invention

The invention further provides asphalt mixtures comprising rock and the mixtures of the invention.

The asphalt mixtures are for the purposes of the invention a natural or industrially produced mixture comprising bitumen and rock (rock aggregates). This is used preferably in road construction for strengthening road surfaces, in building construction for floor coverings, in hydraulic engineering and in landfill construction for waterproofing. The mixing ratio is preferably 90-95% by weight of rock/rock aggregate and approx. 5-10% by weight of bitumen. This ratio can however be altered in an upward or downward direction. The added amount (referred to as the binder content) and the hardness (i.e. the type of binder) of the bitumen alter the behaviour of the material considerably.

The rock is for the purposes of the invention preferably natural rock aggregates, preferably in accordance with DIN EN 13043, that have preferably undergone a mechanical preparation, for example crushing and sieving.

Rock aggregates employed for the asphalt mix for the construction of traffic surfaces must meet the requirements of DIN EN 13043 and the TL Gestein-StB 04 [German technical conditions of supply for rock aggregates in road construction]. Asphalt top layer mix is for example made up of rock aggregates having a maximum particle size of up to 16 mm.

The requirements for rock aggregates are defined inter alia in DIN 18196 “Earthworks and foundations-Soil classification for civil engineering purposes” and the TL Gestein-StB, 2004 version (p. 11).

The rock is present here preferably either in uncrushed form (as round particles), in particular as gravel, sand, crushed stone and chippings, or in crushed form.

The amount of rock is preferably up to 95% by weight, preferably 90% to 95% by weight, based on the total amount of bitumen.

With regard to the bitumen used in the asphalt mixtures of the invention and to the sulfurized C₅-C₃₀ fatty acid and/or esters thereof with a monofunctional C₁-C₈ alcohol, reference is made to the above statements on the mixtures of the invention.

In one embodiment, the asphalt mixture of the invention comprises further added substances and/or fillers, such as fibre materials, or metal compounds/salts, for example organic zinc compounds/salts that function inter alia as sulfide scavengers and thus as odour reducers.

In a further preferred embodiment of the invention, the asphalt mixture has the following composition:
bitumen: 4-8% by weight,
rock: 80-96% by weight,
sulfurized C₅-C₃₀ fatty acid and/or esters thereof with a monofunctional C₁-C₈ alcohol: 0.001-2% by weight, preferably 0.1% to 1% by weight, and
optionally further added substances and/or fillers: 0-20% by weight and
optionally vulcanized rubber, which has preferably been treated with dialkyl polysulfide of the formula (III), the sum total of the constituents coming to 100% by weight.

The present invention further provides in addition a method for producing the asphalt mixtures of the invention, in which at least the mixture of the invention is mixed with the rock at temperatures of 100 to 200° C. The dialkyl polysulfide of the formula (III) is preferably added to the rubber in a separate step before the rubber thus treated is mixed with the bitumen.

In a preferred embodiment of the invention, the sulfurized C₅-C₃₀ fatty acid and/or the C₁-C₈ alkyl ester of the sulfurized fatty acid with a monofunctional C₁-C₈ alcohol is compounds of the formulas (I) and/or (II).

Mixing is effected preferably under mechanical stress in an asphalt mixing unit. Continuous or discontinuous mixing processes may be used here and the employed units may be stationary, readily movable or on castors.

The present invention further provides for the use of the asphalt mixture of the invention in road construction as binder for the rock aggregates in asphalt, preferably as a road surface.

The present invention further provides for the use of mixtures comprising bitumen and at least one sulfurized C₅-C₃₀ fatty acid and/or esters thereof with a monofunctional C₁-C₈ alcohol having a sulfur content of 1% to 29% by weight, preferably 8-29% by weight, more preferably 10-27% by weight and most preferably 10-20% by weight and a proportion of di- and/or triglycerides of ≤5% by weight for reducing the processing temperature of asphalt.

The present invention will be elucidated more particularly with reference to the following examples, the present invention being in no way limited to said examples.

### EXPERIMENT EXAMPLES

The following mixtures were used here:

Road bitumen of type 50/70 from Shell AG.

Asphalt mix of type AC 11 D S: Asphalt concrete with rock of rhyolite type (quartz porphyry) with an upper particle size of 11 mm for a top layer (D) with heavy stress(S)

### As Sulfurized Additives:

Additive 1) Sulfurized methyl ester of rapeseed fatty acid: S content: 17% by weight, kinematic viscosity: 55 mm²/s at 40° C., di-/triglycerides ≤1% by weight, number-average molar mass Mn ˜600 g·mol⁻¹,
Additive 2) Sulfurized palm oil: S content: 6% by weight, triglyceride content: >90% by weight, kinematic viscosity: 250 mm²/s at 40° C., produced in the laboratory in accordance with the teaching of EP-A-3262083, number-average molar mass Mn ˜890 g·mol⁻¹,
Additive 3) Sulfurized rapeseed oil: S content: 15% by weight, triglyceride content: >90% by weight, kinematic viscosity: 300 mm²/s at 40° C., number-average molar mass Mn ˜890 g·mol⁻¹,
Additive 4) Sulfurized oleic acid: S content: 15%, di-/triglyceride content: <1% by weight, kinematic viscosity: 500 mm²/s at 40° C., number-average molar mass Mn ˜490 g·mol⁻¹

The number-average molar mass Mn was determined by gel-permeation chromatography (GPC) measurement at 40° C. using a RI detector with tetrahydrofuran (THF) as eluent and with the “PSS-SDV” column combination from the supplier PSS as stationary phase (molecular weight range between 100 and 10 000 g/mol; column length 300 mm; column diameter 8 mm; particle size 5 μm; pore size 100, 500 and 10 000 Å), which was calibrated with polystyrene standards.

### Example 1: Testing Using Bitumen Typing Quick Procedure (BTSV)

In the following experiments, various additives were added in varying proportions to type 50/70 road bitumen and tested using a bitumen typing quick procedure (BTSV). The BTSV procedure makes it possible to differentiate between modified and unmodified bitumen in the upper range of the use temperature. The two key parameters of the BTSV are the temperature T_{BTSV}, for which the complex shear modulus G* is 15 kPa, and the associated phase angle δ_{BTSV}.

The measurements were carried out in accordance with European test standard EN 14770 but, instead of the isothermal conditions described therein, the temperature was steadily increased from 20° C. to 90° C. during the measurement (ΔT=1.2 K/min, difference from ring and ball softening point with 5 K/min). The oscillating deformation is set to a frequency of 1.59 Hz.

The mixtures were produced as follows: In the following experiments, the above sulfurized additives 1) and 3) were added to the type 50/70 road bitumen in the proportions shown in the table. For this, the type 50/70 bitumen was heated to 170° C., the appropriate additive as per the table added while stirring, and the mixture then stirred for a further 20 minutes. The results are shown in Table 1.

TABLE 1
BTSV measurements of additized bitumens: comparison

| | T_{BTSV} | |
|---|---|---|
| Bitumen variant 50/70 + additive | in ° C. | δ_{BTSV} |
| Without additive (comp.) | 54.7 | 83.1 |
| 3% additive 1: sulfurized methyl ester of rapeseed fatty | 48.1 | 82.9 |
| acid, S content: 17 wt %, di-/triglycerides ≤1 wt % (inv.) | | |
| 6% additive 1: sulfurized methyl ester of rapeseed fatty | 41.9 | 82.8 |
| acid, S content: 17 wt %, di-/triglycerides ≤1 wt % (inv.) | | |
| 3% additive 3: sulfurized rapeseed oil (S content 15 | 50.3 | 84.2 |
| wt %, di-/triglycerides: >90 wt % (comp.) | | |

inv. = inventive,
comp. = comparative example

As can be seen from the examples, mixtures according to the invention lower the T_{BTSV} significantly and are eminently suitable for lowering the processing temperature of hot asphalt. It should also be noted that the phase angle δ_{BTSV} for road bitumen exhibits a typical value of approx. 83°.

### Example 2: Determination of Compaction Temperature, Bulk Density and Marshall Compaction Temperature

The compaction temperature and bulk density and the Marshall compaction temperature extrapolated therefrom were determined for a bulk density of 2.302 [g/cm³] in accordance with the Technical Test Conditions (TP) for asphalt for road construction, FGSV No. 756, part 30: Production of Marshall test specimens using the Marshall compaction apparatus (MVG) and also the “Information sheet for temperature lowering in asphalt”, 2011 version, of the FGSV [German Road and Transportation Research Association]. These tests used a type AC 11 D S asphalt mix (which corresponds to an asphalt concrete having a rock particle size of 11 mm for top layers with heavy stress) and, as binder, a type 50/70 road bitumen or variant thereof additized as described above. Compaction temperatures of 100° C., 110° C., 135° C. and 150° C. were chosen, with 135° C. used as reference for compaction without additive. Each side of the test specimen was exposed to 50 compaction strokes. The results are shown in Table 2.

TABLE 2

| | | | Marshall |
|---|---|---|---|
| | | | compaction |
| | | | temperature |
| | | | in ° C. |
| | Compaction | Bulk | for bulk |
| Asphalt mix, type AC 11 | temperature | density | density of |
| D S with bitumen 50/70 | [° C.] | [g/cm³] | 2.302 [g/cm³] |
| without additive (comp.) | 135 | 2.302 | 135 |
| +3 wt % additive 1 = sulfurized | 100 | 2.297 | 103 |
| methyl ester of rapeseed fatty | 110 | 2.311 | |
| acid (S content 17 wt %), | 135 | 2.325 | |
| di-/triglycerides ≤1 wt % | 150 | 2.329 | |
| (inv.) | | | |
| +3 wt % additive 3 = sulfurized | 100 | 2.279 | 121 |
| rapeseed oil (15% S), | 110 | 2.290 | |
| di-/triglycerides: >90 wt % | 135 | 2.317 | |
| (comp.) | 150 | 2.317 | |
| +3 wt % additive 2 = | 100 | 2.292 | 120 |
| sulfurized palm oil (S content: | 110 | 2.290 | |
| 6%) di-/triglycerides: >90% | 135 | 2.313 | |
| (comp.) | 150 | 2.325 | |
| +3 wt % additive 4 = sulfurized | 100 | 2.291 | 112 |
| oleic acid 15 wt % S, di-/ | 110 | 2.300 | |
| triglyceride content: <1 wt % | 135 | 2.327 | |
| (inv.) | 150 | 2.329 | |

inv. = inventive,
comp. = comparative example

As can be seen, the temperature-lowering effect during compaction when using the sulfurized methyl ester of rapeseed fatty acid and sulfurized oleic acid employed in accordance with the invention is very pronounced. Here, lowerings of >30 K (sulfurized methyl ester) and >20 K (sulfurized oleic acid) are achieved; in the case of sulfurized rapeseed oil and palm oil the effect with otherwise the same level of dosing is only half as great. The use of the mixtures of the invention resulted in an asphalt mixture with a considerable reduction in emissions and accordingly improved health protection during road construction.

1. A mixture comprising bitumen and at least one sulfurized C₅-C₃₀ fatty acid and/or esters thereof with a monofunctional C₁-C₈ alcohol having a sulfur content of 1% to 29% by weight and a proportion of di- and/or triglycerides of ≤5% by weight.

2. The mixture according to claim 1, wherein the mixture comprises, as sulfurized fatty acid and/or esters thereof, compounds of the formula (I) 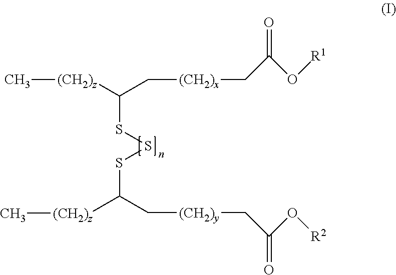
where
n=0-8,
R¹═H, C₁-C₃ alkyl,
R²═H, C₁-C₈alkyl,
x=0-10,
y=0-10,
z=independently 0-20
and/or of the formula (II) 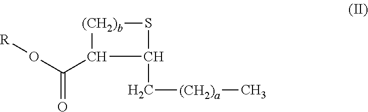
where
a=0-26,
b=0-3 and
R═H, C₁-C₈alkyl.

3. The mixture according to claim 1, wherein the sulfurized C₅-C₃₀ fatty acid is aliphatic monocarboxylic acids from triglycerides obtained from natural oils such as palm oil, sunflower oil, maize oil, soya oil, linseed oil, rapeseed oil, tung oil, castor oil, tall oil, cottonseed oil, peanut oil, safflower oil, and/or maize stillage oil and sulfurized by reaction with elemental sulfur and optionally hydrogen sulfide.

4. The mixture according to claim 1, wherein the proportion of sulfur in the sulfurized C₅-C₃₀ fatty acid and/or esters thereof with a monofunctional C₁-C₈ alcohol is 8-29% by weight.

5. The mixture according to any of claim 1, wherein the sulfurized C₅-C₃₀ fatty acid and/or esters thereof with a monofunctional C₁-C₈ alcohol has/have a number-average molar mass Mn of <880 g·mol⁻¹.

6. The mixture according to claim 1, wherein the proportion of di- and/or triglycerides is between 0.001 and 0.75% by weight based on the sulfurized C₅-C₃₀ fatty acid and/or esters thereof with a monofunctional C₁-C₈ alcohol.

7. The mixture according to claim 1, wherein vulcanized rubber has been stirred therein, that, prior to being incorporated, was treated with dialkyl polysulfides of the formula (III) 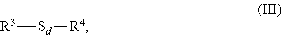
where R³ and R⁴ may be identical or different and represent a linear or branched C₁-C₁₈ alkyl radical and d represents numbers from 3 to 12.

8. A method for producing the mixture according to any of claim 1, characterized in that wherein bitumen is mixed at temperatures of 100 to 200° C. with at least one sulfurized C₅-C₃₆ fatty acid and/or esters thereof with a monofunctional C₁-C₈ alcohol having a sulfur content of 8% to 29% by weight and a proportion of di- and/or triglycerides of ≤5% by weight and optionally dialkyl polysulfide of the formula (III) and vulcanized rubber.

9. An asphalt mixture comprising rock and the mixture according to claim 1.

10. A method for producing the asphalt mixture according to claim 9, wherein the mixture according to claim 1 is mixed with the rock at temperatures of 100 to 200° C.

11. A method of binding rock aggregates in asphalt comprising incorporating the mixture according to claim 1 in asphalt used in road construction and as a road surface.

12. A method of reducing a processing temperature of asphalt comprising incorporating the mixture according to claim 1 into the asphalt.

13. The mixture according to claim 1, wherein the proportion of sulfur in the sulfurized C₅-C₃₀ fatty acid and/or esters thereof with a monofunctional C₁-C₈ alcohol is 10-27% by weight.

14. The mixture according to claim 1, wherein the proportion of sulfur in the sulfurized C₅-C₃₀ fatty acid and/or esters thereof with a monofunctional C₁-C₈ alcohol is 10-20% by weight.

15. The mixture according to any of claim 1, wherein the sulfurized C₅-C₃₀ fatty acid and/or esters thereof with a monofunctional C₁-C₈ alcohol has/have a number-average molar mass Mn between 350 and 750 g·mol⁻¹.

16. The mixture according to any of claim 1, wherein the sulfurized C₅-C₃₀ fatty acid and/or esters thereof with a monofunctional C₁-C₈ alcohol has/have a number-average molar mass Mn from 450 to 680 g·mol⁻¹.
